(19) United States
(12) Patent Application Publication
(10) Pub. No.: US 2013/0211852 A1
(43) Pub. Date: Aug. 15, 2013

(54) MULTIMODAL PHYSIOLOGIC DATA STATION AND WELLNESS TRANSFORMATION OF LARGE POPULATIONS

(71) Applicant: The Cleveland Clinic Foundation, (US)

(72) Inventors: Michael F. Roizen, Shaker Heights, OH (US); Barry D. Kuban, Avon Lake, OH (US)

(73) Assignee: THE CLEVELAND CLINIC FOUNDATION, Cleveland, OH (US)

(21) Appl. No.: 13/767,249

(22) Filed: Feb. 14, 2013

Related U.S. Application Data
(60) Provisional application No. 61/598,923, filed on Feb. 15, 2012.

(51) Int. Cl. G06Q 10/06; G06Q 50/22

(52) U.S. Cl. CPC G06Q 10/063; G06Q 50/22
USPC 705/2

(57) ABSTRACT

A method includes determining team participant members for one or more wellness teams. The method includes aggregating participant medical data for each of the one or more wellness teams from one or more networked physiologic stations configured to receive the medical data. The method includes analyzing the medical data to determine wellness information for the one or more wellness teams associated with the aggregated participant medical data. The method can be operated on a system where the system includes at least one physiologic station to generate participant medical information from a plurality of participants. This can include an identification component to facilitate trust in collected data. A storage medium collects the medical information over a network from the plurality of participants and an analyzer determines group wellness information from the collected medical information.

### CROSS-REFERENCE TO RELATED APPLICATION

This application claims the benefit of U.S. Provisional Patent Application No. 61/598,923 filed on Feb. 15, 2012, and entitled MULTIMODAL PHYSIOLOGIC DATA STATION AND WELLNESS TRANSFORMATION OF LARGE POPULATIONS, the entirety of which is incorporated by reference herein.

### TECHNICAL FIELD

The present invention relates to systems and methodologies for automated, nonbiased, physiologic data collection, and, in particular, is directed to systems and methods for automatically generating and collecting physiologic data from networked multimodal data stations to facilitate wellness and social media connections and competitions of and between large populations.

### BACKGROUND OF THE INVENTION

It is no secret that obesity, diabetes, and heart disease among other ailments have been steadily on the rise in advanced western countries for many years. One only need to look at the number of heart surgeries performed each year, for example, to confirm this simple, yet troubling truth. While modern medicine is unbelievably advanced in its ability to provide services such as advanced surgery techniques for heart disease and leading-edge drugs such as statins to control cholesterol, for example, these approaches are more reactive than proactive in treating the underlying problems leading to disease. One of the problems with current treatment options is that it often takes months for patients to schedule an appointment with their doctors and worse yet, many do not feel incentivized to even do so until unfortunately hypertension or worse forces their health-related decision. While it is well established that patient health can be dramatically improved with a combination of monitoring and patient-physician interaction, the cost, time and inconvenience involved is a major hurdle. Some online programs are helping patients receive the information and encouragement they need, but rely on patients for input of their physiologic data. However, such patient-entered data is often inaccurate and incomplete. Moreover, the online services currently available do not proactively encourage patients to interact with their physicians or other health professionals on a regular basis.

### SUMMARY OF THE INVENTION

A method for automated physiologic data collection includes includes determining team participant members for one or more wellness teams. The method includes aggregating participant medical data for each of the one or more wellness teams from one or more networked physiologic stations configured to receive the medical data. The method includes analyzing the medical data to determine wellness information for the one or more wellness teams associated with the aggregated participant medical data.

In another aspect, a system for physiologic data collection is provided. The system includes at least one physiologic station configured to generate participant medical or wellness related information from a plurality of participants in a verifiable manner that facilitates the result (e.g., the participants are what and whom they purport to be and can be trusted by competing participants). The system includes a storage medium configured to collect the medical information over a network from participants in many competing locales. The system also includes an analyzer configured to determine group information and competitive information from the collected medical information. Further, the system allows differentiation of rewards or insurance rates by enabling validation of physiologic data.

### BRIEF DESCRIPTION OF THE DRAWINGS

FIG. 1 illustrates an example of a multimodal physiologic data collection system in accordance with an aspect of the present invention.

FIG. 2 illustrates example components of a multimodal collection system in accordance with an aspect of the present invention.

FIGS. 3-5 illustrate example output displays for a multimodal collection system in accordance with an aspect of the present invention.

FIG. 6 illustrates an example method for collecting data from a multimodal collection system in accordance with an aspect of the present invention.

FIG. 7 illustrates an example method for multimodal physiologic data collection in accordance with an aspect of the present invention.

FIG. 8 illustrates an example method for team wellness data collection in accordance with an aspect of the present invention.

FIG. 9 illustrates an example schematic of a multimodal collection station that can be employed with multimodal physiologic data collection in accordance with an aspect of the present invention.

### DETAILED DESCRIPTION

Automated physiologic data collection and verification methods are provided to proactively encourage health and physical transformation of group participants such as from teams composed of large groups (e.g., 50 or more members per team). Such team participation can include various competitions and social media generated competition using validated data to promote wellness of large populations. For example, grade 3 competitors in PS 8 versus PS16, or competitors in Cleveland Heights versus East Cleveland versus any of various neighborhoods, cities or towns, or competitors from companies such as one company's plants nationwide or throughout the world. Competitions can be conducted within and/or between substantially any type of entity such as between or within companies, between and/or within institutions, between and/or within neighborhoods, between and/or within towns, or between and/or within cities, for example.

Such automated systems can validate data collection from team participants and can be provided by networked measuring stations placed in convenient locations such as pharmacies and retail outlets, for example. This can include automated identification such as face and body recognition to encourage participation and trust of large populations in such events as nation-wide city health challenges. These challenges can be offered to groups or teams to determine which city has collectively lost the most weight and/or measured against other health-related parameters or variables, for example. Such challenges are but one method to transform habits of large groups and facilitate wellness within populations by incentivizing group/team members to participate through convenience, automation, competitive challenge, and social media, for example. Other methods include incentives in the form of in-store vouchers, electronic credits, or coupons provided at the measuring station as a reward for team participation, or for validated trusted changes in physiologic variables, for example.

The measuring stations can utilize electronic identification cards and biomarkers such as retinal scans or fingerprints to authenticate and verify the participants to mitigate the potential for fraud. When verified, a team or group participant's medical data such as height, weight, and waist size, for example, can be automatically collected via height and size validation pictures and software for example, and transmitted to a network database where such data can be aggregated or compared to, or with, other participants. In addition, a participant's individual data along with group/team participant data can be analyzed by automated services or relayed to a professional team of coaches, physicians, or other professionals for feedback and analysis of potential concerns or to offer further encouragement. By providing a convenient and incentivized platform to encourage participation, group wellness of large populations can be significantly enhanced in a proactive manner and before more serious health issues may arise.

Automated methods include aggregating group/team participant medical data from networked physiologic stations that are configured to receive the data. This includes automatically analyzing the medical data to determine wellness information for a group of participants which can include large populations identified within an entity such as cities or countries, for example. To ensure compliance with contests or other incentives to participate, verification and authentication methods can include scanning a card with a biomarker to validate the originator of the participant medical data. This can include sorting the participant medical data into a relational database, for example wherein further automated analysis such as machine learning or data mining can be applied.

Automated measurements from the stations can include capturing images to verify height, waist size, body mass index (BMI), and waist-to-height ratios, for example. Such data can be aggregated across and/or within entities such as teams, towns, countries, or companies, for example, to enable validated weight loss competitions and validated BMI or waist loss competitions, for example. Biologic markers such as heart rate, blood sugar, or cholesterol, for example can be aggregated, entered into a relational database, and transmitted to emergency medical rooms, coaching professionals, or social media based competitions, for example, for further analysis or reward. The physiologic stations can provide interactive screens to allow for answering health or related food questions, for example. Such interactivity can also include providing health, promotional, and/or instructional material to medical data participants, for example.

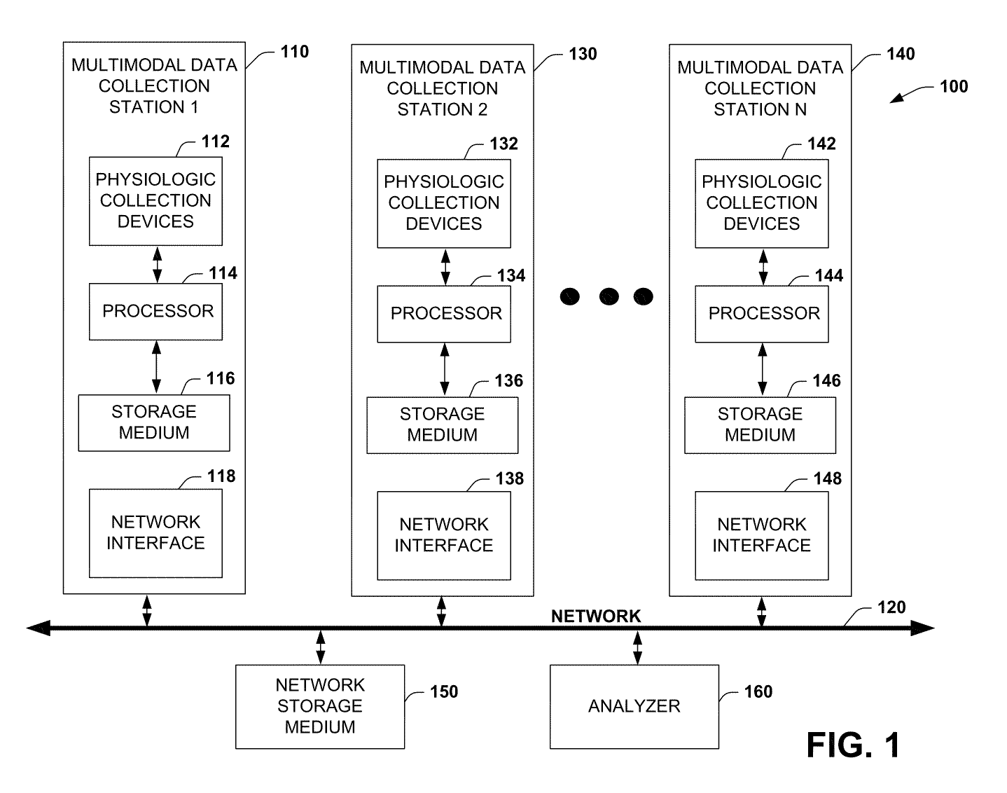

FIG. 1 illustrates an example of a multimodal physiologic data collection system 100. The system 100 includes at least one multimodal data collection station 110 (also referred to as station 1 or station) that includes various physiologic collection devices 112. As used herein, physiologic collection refers to any patient or participant information that can be received and automatically recorded at the station 110 such as blood pressure, weight, temperature, heart rate, breath analysis, biological samples such as blood or skin moisture, and so forth. Such collection devices 112 can include biometric devices, heart rate monitors, thermometers, weight scales, and so forth that are all monitored by a processor 114. The physiologic collection devices 112 can also include security identification components (e.g., retinal scanners, fingerprint analyzers) to identify the individual providing the physiologic data and mitigate fraud in the event of a contest or challenge. The collected physiologic data can be stored locally at a storage medium 116 and later uploaded via a network interface 118 to a network 120. The network 120 can include local networks such as within a facility such as a pharmacy or retail outlet, wherein such local networks can be connected to broader networks such as the Internet, for example.

As shown, the system 100 can include a plurality of multimodal stations shown as station 2 at 130 and station N at 140, wherein N represents a positive integer. Station 2 at 130 also includes physiologic collection devices 132, processor 134, storage medium 136, and network interface 138. Similarly, station N at 140 can include physiologic collection devices 142, processor 144, storage medium 146, and network interface 148. When physiologic data has been collected at the respective stations 110, 130, and 140, the data can be uploaded via the network 120 to a network storage medium 150 and aggregated therein. The network storage medium 120 can be a server farm or connected network of storage devices such as can be provided by cloud storage services, for example. Also, an analyzer 160 can be provided to perform analysis on the aggregated physiologic data in the storage medium 150. Such analysis can include comparing team participants in a contest (e.g., which participant or group has lost the most weight) or can include detailed and long term studies such as analyzing the health or wellness of team participants who live in the same area or who are similarly situated demographically. The analyzer 160 can include automated and expert systems for analyzing data such as neural networks, trained classifiers, and data mining capabilities, for example.

The stations 110, 120, and 130 can be used in common locations at or away from a physician's office allowing participants to document several physiologic measurements in a convenient and efficient manner. The physiologic collection devices include a biometric identification system to positively identify the participant and their data and can be connected via the Internet (or other method) to the network storage medium 150 where the information can be used to monitor health status and as input to one or more software systems for health tracking and intervention. The system 100 can automatically alert coaches and/or medical experts of progress, problems, or emergency situations, for example.

The physiologic measurements stations can include, but are not be limited to: weight, pedometer steps, calorie intake, waist size, blood pressure, heart rate, blood glucose, HgAlC, advanced glycation end products (AGEs), pulse co-oximetry, breath, volatile organic compounds, and so forth. The system 100 can utilize a wireless communication link (e.g., Bluetooth) to automatically download data from patient devices such as pedometers, and also a video screen that can stream entertaining and/or informational content, and display updates from the expert system via the network connection 120. This type of feedback can be utilized for patients to track health and progress. The display feedback can also provide incentives such as competitive challenges, coupons, vouchers, and so forth to incentivize participants to continue to have their health and wellness monitored.

The system 100 can automatically perform several physiologic measurements concurrently. This includes biometric input and network connectivity to positively identify a patient and download data to the network storage medium 150. Automatic measurements can include waist size, automatically and non-invasively assessing glucose tolerance, or recent smoking activity, for example. The system 100 can perform such actions (e.g., at local pharmacy) using an affinity card and a second source of identification that facilitates trust such as a fingerprint, retinal scan, or other biometric identifier for a large number of participants or patients that can communicate with a database that alerts coaches and/or medical professionals of needed coaching and so forth. Two example aspects for automated measurements include skin auto-fluorescence for measurement of AGEs which correlate with glucose tolerance, and pulse co-oximetry or breath analysis for smoking assessment. An advantage of breath analysis is the added input of blood alcohol content, for example.

Individuals can potentially benefit from the automated data collection stations since money spent on unnecessary office visits can be saved while promoting healthier living, thus reducing future health issues and the cost of treatment. This includes the ability to send accurate, pertinent health data to an expert system and analyzer 160 from the convenience of the super market, mall, or even from home, and receive timely feedback on progress and potential problems at a fraction of the cost of regular office visits. Further, the identification process (e.g., dual identification) and ability to store initial, final and/or multiple pictures on a scale that enables validation of individual and height and waist measurements further engenders trust in the competition. Thus, an advantage of the system 100 is the automatic, biometrically verified, inexpensive, non-invasive measurement and transmission of patient physiologic data to an expert system (or monitoring expert) for evaluation rather than relying on the patient to perform measurements and self-report activities. This can provide more accurate, and more complete information than the patient can perform by themselves.

In another example, the system 100 can be applied toward the wellness of groups such as teams, where data is aggregated or collected over a population of individuals to determine information. For example, a networked system of stations could be employed in a multi-city challenge to monitor group/team participation and identify weight-loss winners, for example, or other selected criteria such as blood pressure. Furthermore, the identification process (e.g., dual identification) and ability to store initial, final, or multiple pictures on a scale that enables validation of individuals including height and waist measurements further engenders trust in the competition. The system 100 could also be employed to study characteristics of groups. This could include monitoring certain locations to see if the population was suffering from any adverse effects such as contamination of a water supply, for example. Thus, a comparison could be made between group participants who were not exposed to the contamination to those who were. Substantially any type of wellness study could be conducted such as trying to determine the effects of diet on subjects in lower income neighborhoods versus more well-to-do locations. Substantially any type of demographic or social condition could be studied by utilizing such information when the participant logged in at the station and later had their respective data aggregated with other similarly situated participants.

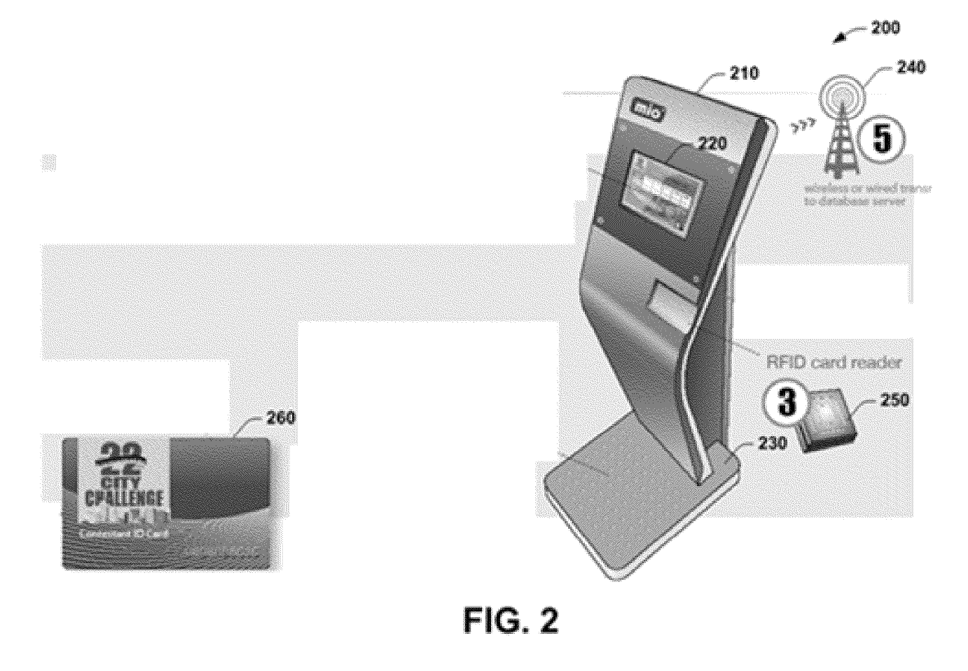

FIG. 2 illustrates example components of a multimodal collection system 200. The system 200 can be employed as an automated collection station 210 of physiologic data from group participants competing in a nation-wide contest or for individuals who want to have their health conveniently monitored on a regular basis. Further, the identification process and ability to store initial, final, and multiple pictures on a scale that enables validation of individual and height and waist measurements, for example, further engenders trust in the competition. The collection station can include a touch screen personal computer 220 to receive participant input, offer incentive, and provide ongoing health progress. As shown, a digital scale at 230 can be provided to automatically measure weight and transmit such information via wireless network 240.

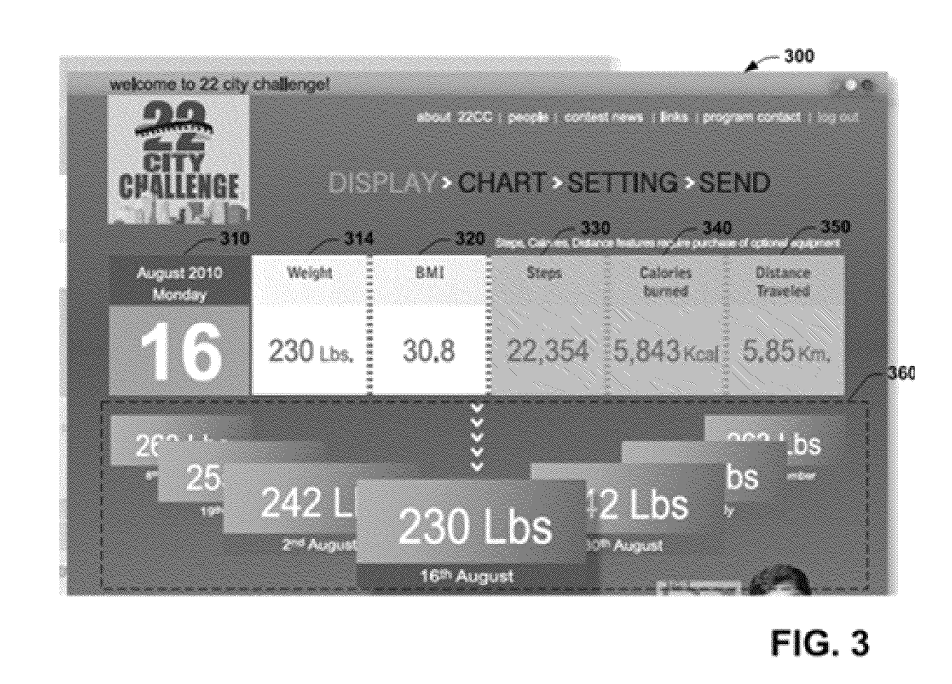

The collection station 210 can include an RFID scanner 250 to verify a participant's identity via electronic card 260. The card 260 can provide an image of the participant that can be used by clerks working at retail outlets to verify identity of the participant. The images and biometric data can be saved with the collected records from the participant as further verification of who provided the information. In addition, biomarker information can be collected along with the card information such as via retinal scanners or fingerprint scanners (not shown) for further authentication and verification of participation. FIGS. 3-5 will now be described which show example output displays from the personal computer 220. Such displays can help to monitor progress, offer coaching advice, show distance to goals, show trend analysis, and provide incentives among other alternatives. In addition to incentives, targeted advertising could be provided that can be based on various parameters (e.g., competition type, health issue being monitored, location of monitoring, data provided by participant, and so forth). This can include advertising based on competition type (e.g., weight loss products advertised for weight loss competitors), the type of health issue being monitored (e.g., if diabetes being monitored, advertise diabetes products), the location (e.g., pharmacy ads may be different than retail outlet ads), data provided by participants such as in an electronic profile, and other factors such as answering questions that may be automatically posed during participation to determine current health status.

FIG. 3 illustrates an example output display 300 that can be provided by a multimodal collection station. As shown, the display 300 can include the respective date at 310, current weight at 314, BMI at 320, a number of steps taken at 330, calories burned at 340, and distance traveled at 350. The display 300 can also provide historic tracking such as weight tracking shown inside box 360.

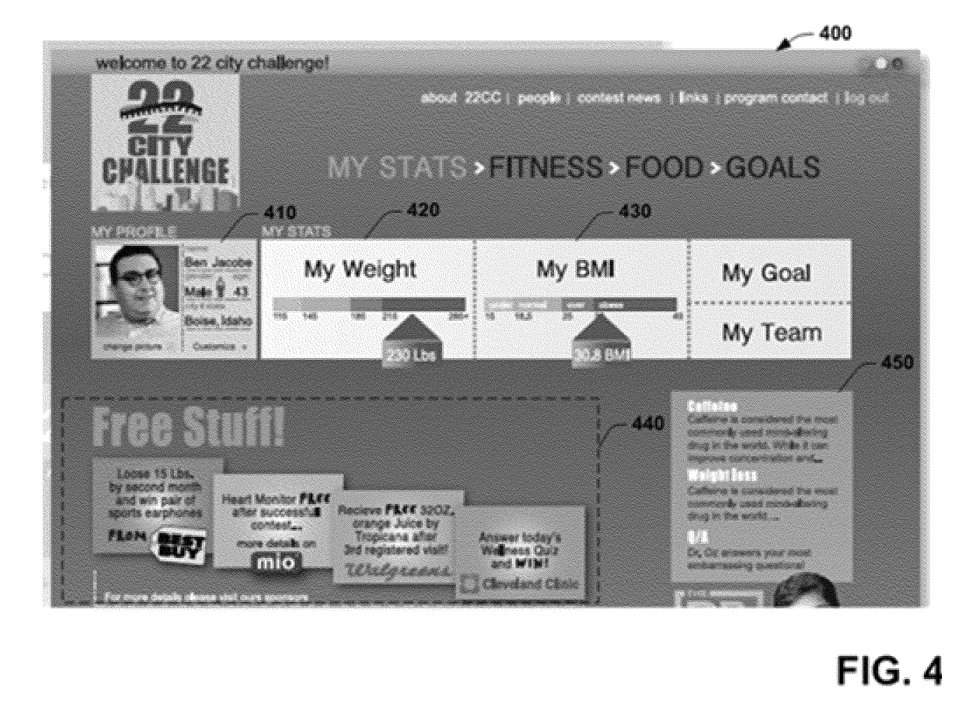

FIG. 4 illustrates some example incentive displays at display output 400. Such output 400, can include a profile output at 410 including an image of the participant, name, age, location, and so forth. Goals can be displayed for both the individual participant and associated team if in a collective competition such as shown at 420 for weight progress and 430 for BMI progress. Example incentive awards are shown at box 440 and expert advice can be offered at 450.

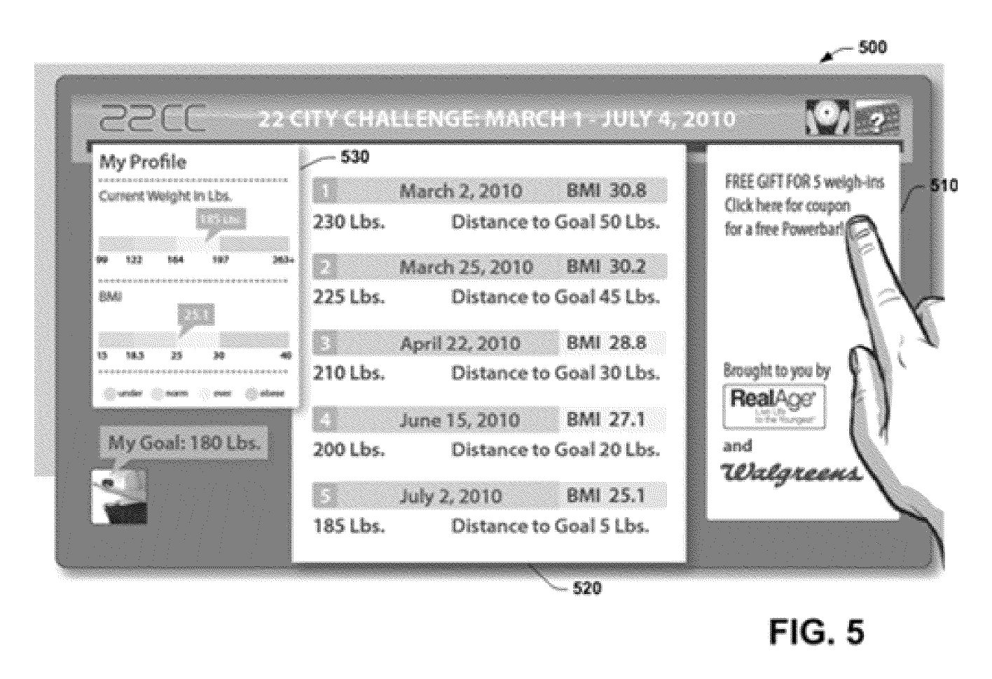

FIG. 5 illustrates a display output 500 showing how participants can select an incentive reward for participation. As shown at 510, a participant selects a desired reward for participating on a given day. Such rewards can be administered electronically such as providing credits to an account at a given retail store or administered via hard copy such as via a printer, for example. At 520, the output 500 depicts a participant's progress over various measuring dates. In this example, five different dates are shown with each date showing measured weights, distance to desired weight goals, and BMI progress. As can be appreciated, other criteria or measured parameters as previously described could also be collected, tracked, and/or displayed. At 530, profile information can be displayed current weight, BMI, and how such information compares to a group of participants.

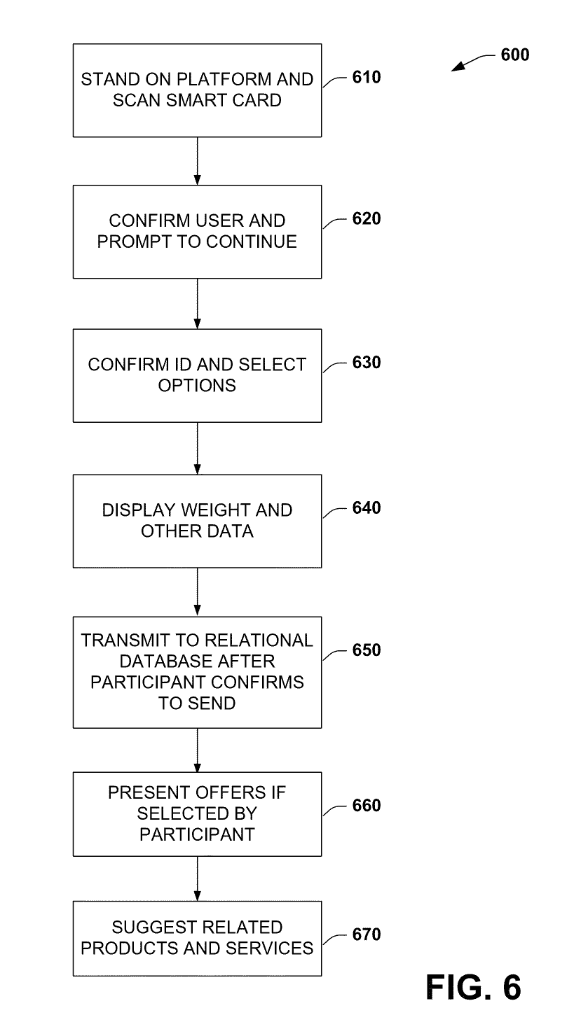

In view of the foregoing structural and functional features described above, example methods will be better appreciated with reference to FIGS. 6, 7, and 8. While, for purposes of simplicity of explanation, the methods are shown and described as executing serially, it is to be understood and appreciated that the methods are not limited by the illustrated order, as parts of the methods could occur in different orders and/or concurrently from that shown and described herein. Such methods can be executed by various components configured in an integrated circuit or a controller, for example.

FIG. 6 illustrates an example method 600 for collecting data from a multimodal collection system in accordance with an aspect of the present invention. At 610, the method 600 includes having a participant stand on a platform where their electronic card can be scanned for verification. As noted previously, this can also include the collection of biomarker information in addition to the electronic card. At 620, the method 600 confirms the user and generates a prompts the participant to continue if the identification is verified. Verification can include having a local clerk near the collection system to verity the image received from the card is the same person who is standing on the platform. After confirming the identification at 630, the participant selects from available options at a display screen. This can include entry of participant data into a contest, updating a database, or merely checking in for ongoing health monitoring and coaching.

At 640, the method 600 displays participant weight and other data such as body mass index (BMI), calories burned since last visit, group standings, and so forth. At 650, the method 600 transmits the collected participant information to a relational database after confirmation from the participant (e.g., voice instruction to send, selecting send on a touch pad, and so forth). At 660, the method 600 presents offers (if any) such as in-store vouchers, coupons, electronic credits, or other incentives for participating. At 670, the method 600 includes suggesting related products and services (if any) that may be of interest to the respective participant. This can include targeted advertising as discussed previously (e.g., based on competition type, location, health issue, profile, and so forth). Participants can also be given various interfaces to configure their own personal experience such as disabling certain advertisements, signing up for other awards, and offering to participate in other studies, for example.

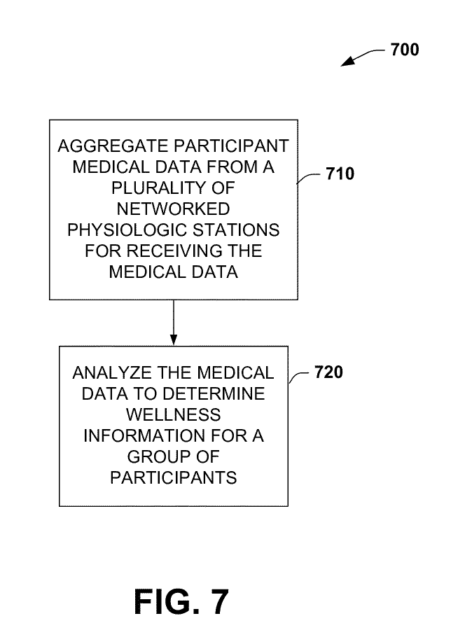

FIG. 7 illustrates an example method 700 for multimodal physiologic data collection. The method 700 for automated physiologic data collection includes aggregating participant medical data from a plurality of networked physiologic stations configured to receive the medical data at 710. The method 700 includes analyzing the medical data to determine wellness information for a group of participants at 720. In addition to determining wellness information for groups, the method 700 can also include utilizing the aggregated data in a contest where participants report their vital statistics such as weight or other statistic to receive awards or other incentives.

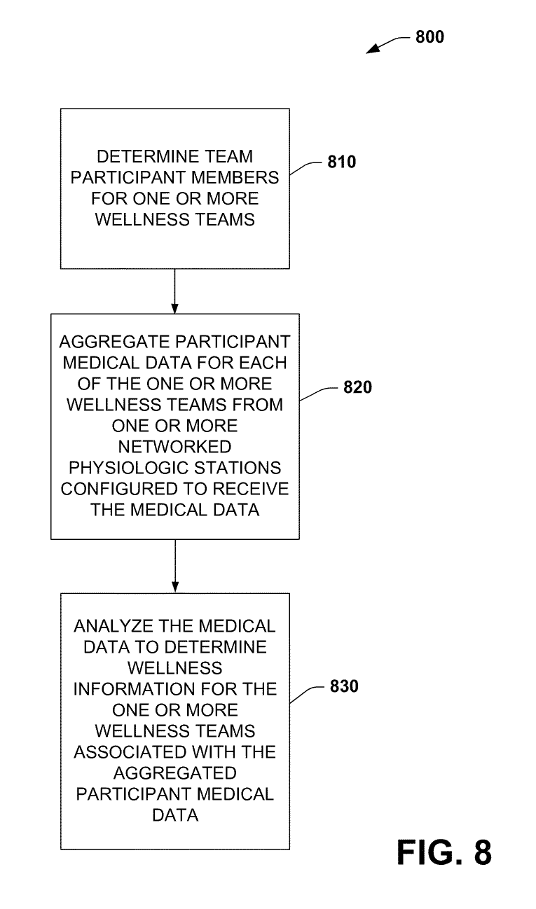

FIG. 8 illustrates an example method 800 for team wellness data collection in accordance with an aspect of the present invention. At 810, the method 800 includes determining team participant members for one or more wellness teams (e.g., via multimodal collection station 110 of FIG. 1). At 820, the method 800 includes aggregating participant medical data for each of the one or more wellness teams from one or more networked physiologic stations configured to receive the medical data (e.g., via network storage medium 150 of FIG. 1). At 830, the method 800 includes analyzing the medical data to determine wellness information for the one or more wellness teams associated with the aggregated participant medical data (e.g., via analyzer 160 of FIG. 1).

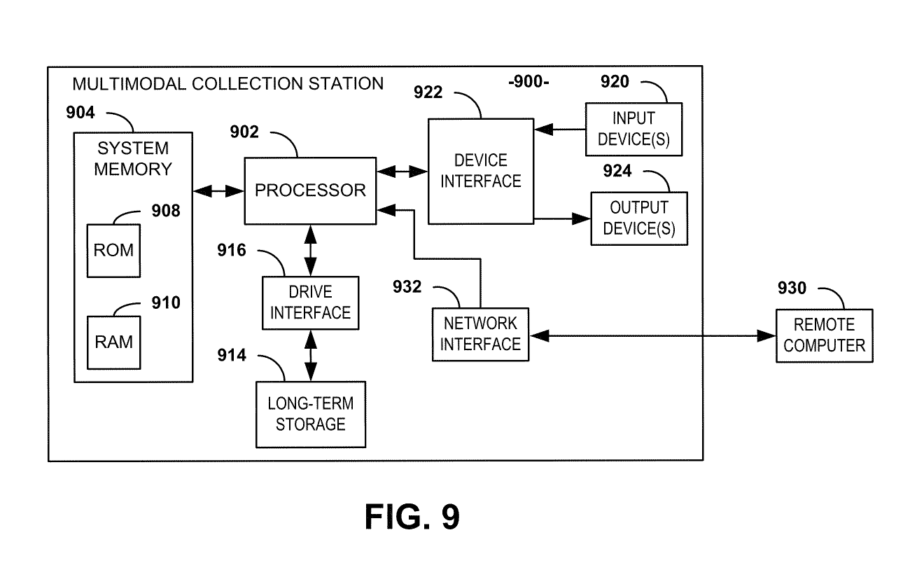

FIG. 9 illustrates a schematic example a multimodal collection station 900 that can be employed to implement multimodal physiologic collection and methods described herein, such as based on computer executable instructions running on the station. The multimodal collection station 900 can include one or more general purpose networked computer systems, embedded computer systems, routers, switches, server devices, client devices, various intermediate devices/nodes and/or stand alone computer systems.

The multimodal collection station 900 includes a processor 902 and a system memory 904. Dual microprocessors and other multi-processor architectures can also be utilized as the processor 902. The processor 902 and system memory 904 can be coupled by any of several types of bus structures, including a memory bus or memory controller, a peripheral bus, and a local bus using any of a variety of bus architectures. The system memory 904 includes read only memory (ROM) 908 and random access memory (RAM) 910. A basic input/output system (BIOS) can reside in the ROM 908, generally containing the basic routines that help to transfer information between elements within the multimodal collection station 900, such as a reset or power-up.

The multimodal collection station 900 can include one or more types of long-term data storage 914, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 902 by a drive interface 916. The long-term storage components 914 provide nonvolatile storage of data, data structures, and computer-executable instructions for the computer system 900. A number of program modules may also be stored in one or more of the drives as well as in the RAM 910, including an operating system, one or more application programs, other program modules, and program data.

A user may enter commands and information into the computer system 900 through one or more input devices 920, such as a keyboard, a touchscreen, physiologic input devices, biomarker readers, photo devices and scales, card scanners, and/or a pointing device (e.g., a mouse). It will be appreciated that the one or more input devices 920 can include one or more physiologic sensor assemblies transmitting data to the multimodal collection station 900 for further processing. These and other input devices are often connected to the processor 902 through a device interface 922. For example, the input devices can be connected to the system bus by one or more a parallel port, a serial port or a USB. One or more output device(s) 924, such as a visual display device or printer, can also be connected to the processor 902 via the device interface 922.

The multimodal collection station 900 may operate in a networked environment using logical connections (e.g., a local area network (LAN) or wide area network (WAN)) to one or more remote computers 930. A given remote computer 930 may be a workstation, a computer system, a router, a peer device, or other common network node, and typically includes many or all of the elements described relative to the computer system 900. The computer system 900 can communicate with the remote computers 930 via a network interface 932, such as a wired or wireless network interface card or modem. In a networked environment, application programs and program data depicted relative to the multimodal collection station 900, or portions thereof, may be stored in memory associated with the remote computers 930.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method, comprising:
determining team participant members for one or more wellness teams;
aggregating participant medical data for each of the one or more wellness teams from one or more networked physiologic stations configured to receive the medical data; and
analyzing the medical data to determine wellness information for the one or more wellness teams associated with the aggregated participant medical data.

2. The method of claim 1, further comprising scanning a card with a biomarker to validate the originator of the participant medical data.

3. The method of claim 1, further comprising sorting the participant medical data into a relational database.

4. The method of claim 1, further comprising capturing images to verify height, waist size, body mass index (BMI), and waist-to-height ratios.

5. The method of claim 1, further comprising capturing multiple identifications to store and compare initial, final, and multiple pictures on a scale that enables validation of individual measurements to facilitate trust in the validity of data collection.

6. The method of claim 1, further comprising aggregating the participant medical data across and/or within an entity, wherein the entity can include neighborhoods, towns, countries, or companies to enable validated weight loss competitions and validated BMI or waist loss competitions.

7. The method of claim 1, further comprising aggregating biologic markers including, heart rate, blood sugar, or cholesterol, entering the biologic markers into a relational database, and transmitting the biologic markers to emergency medical rooms, coaching professionals, or social media based competitions.

8. The method of claim 1, further comprising providing an interactive screen to allow for answering health or related food questions.

9. The method of claim 1, further comprising comparing input data and physiologic data that allows determination of what foods or activities result in changes in physiologic data for an individual or team.

10. The method of claim 1, further comprising providing health, promotional, and instructional material to medical data participants.

11. A system, comprising:
at least one physiologic station to generate participant medical information from a plurality of team participants;
a dual identification component to facilitate trust in collected data from the plurality of team participants;
a storage medium to collect the medical information over a network from the plurality of team participants; and
an analyzer to determine group wellness information from the collected medical information.

12. The system of claim 11, further comprising linking the plurality of team participants in a contest.

13. The system of claim 11, the contest involves determining which team participant or which team has lost the most weight, lost the most amount of fat, lowered their blood pressure the most, changed their cholesterol by the largest amount, or reduced their waste size the most, and what foods or exercises led to the changes.

14. The system of claim 11, further comprising an incentive component to induce the plurality of team participants o provide the participant medical information.

15. The system of claim 14, wherein statistics are applied to the group information to determine the group wellness information.

16. The system of claim 15, wherein trained classifiers or neural networks are employed to analyze the group information.

17. The system of claim 15, wherein the group wellness information is employed to determine health conditions for a group, contamination of a group, or effects of habits on the group.

18. A system, comprising:
a network to communicate medical information from a plurality of team participants;
at least one physiologic station coupled to the network to collect the medical information from the plurality of team participants;
an identification component to authenticate the plurality of team participants before the medical information is collected and communicated on the network;
a storage medium to aggregate the medical information over the network from the plurality of team participants;
an incentive component to induce the plurality of team participants to provide the medical information to the at least one physiologic station; and
an analyzer to determine group wellness information from the collected medical information and determine at least one leader team from the plurality of team participants.

19. The system of claim 19, wherein the identification component is a biometric device to authenticate the plurality of team participants.

20. The system of claim 19, wherein the incentive component is an electronic card that is updated with a reward when a given team participant from the plurality of team participants provides the medical information.
